(19) United States
(12) Patent Application Publication
(10) Pub. No.: US 2019/0355035 A1
(43) Pub. Date: Nov. 21, 2019

(54) Collaborative Software Platform

(71) Applicant: Brian David Anderson, Waco, TX (US)

(72) Inventor: Brian David Anderson, Waco, TX (US)

(21) Appl. No.: 16/524,817

(22) Filed: Jul. 29, 2019

Related U.S. Application Data
(63) Continuation-in-part of application No. 16/180,233, filed on Nov. 5, 2018, now abandoned.
Application No. 16/180,233 is a continuation of application No. 15/914,307, filed on Mar. 7, 2018, now abandoned.
(60) Provisional application No. 62/467,955, filed on Mar. 7, 2017.

(51) Int. Cl. G06Q 30/06; H04L 12/26; H04L 29/08

(52) U.S. Cl. CPC G06Q 30/0619; H04L 67/34; H04L 43/08

(57) ABSTRACT

A system for enabling collaborative development of an idea through resource-sharing is disclosed and described. The system provides a platform for networking that can be utilized by multiple users in order to enable and develop their ideas in a private and safe exchange. Each user is united and able to collaborate through resources in a profile. Resource owners choose how far their information is extended. Furthermore, the platform can quantify the strength of the resource being offered by providing a quantifiable assessment of both the access to and leverage of specific resources in a given profile.

### TECHNICAL FIELD

The present invention relates generally to a collaborative software platform, and in a particular though non-limiting embodiment to a multi-sided, resource-sharing collaborative software platform within which participants both offer and receive tangible and intangible resources to and from a plurality of predefined connections.

### BACKGROUND

Ideas at any scale require resources to become reality. Typically, people with ideas need support but face personal risk reaching out. Moreover, people with resources want to support, but have limited time. Furthermore, people are oftentimes unaware of the relative strength of a given resource. The result is that resources are often within sight but out of reach. Consequently, users are far too often left lacking a marketplace for opportunity that facilitates a resource exchange in a safe and private manner.

The prior art teaches a number of primitive techniques relying on collaborative software for the development of database applications, the storage of personal information, and/or the management of files, yet none teach of a method to use collaborative software for the development of ideas through a multi-sided, resource-sharing platform.

For example:

US 2015/0135160 by Gavin et al. teaches a network-connected computer system for developing computer programs through a social networking service and application development service that are integrated so users are registered to employ the features of the application development service. However, the reference fails to disclose any means or methods for the development of ideas through a multi-sided, resource-sharing platform or the quantification of the strength of such resources.

US 2003/0009740 by Lan teaches a software development system that eliminates barriers between clients and software developers by connecting vendors and buyers online. However, the reference fails to disclose any means or methods for the development of ideas through a multi-sided, resource-sharing platform or the quantification of the strength of such resources.

US 2008/0059943 by Krevs et al. teaches a geographically dispersed software company transferring modules from library cache area to developers' work areas on each developer's development site network node. However, the reference fails to disclose any means or methods for the development of ideas through a multi-sided, resource-sharing platform or the quantification of the strength of such resources.

U.S. Pat. No. 7,870,535 to Rippert, Jr. et al. teaches an online system for developing Internet-hosted business application of web services that uses an Internet-hosted production environment for provisioning and editing modules. However, the reference fails to disclose any means or methods for the development of ideas through a multi-sided, resource-sharing platform or the quantification of the strength of such resources.

WO 2016191629A1 teaches a market for application developers to purchase enhancements to dialog systems from a software developer. However, the reference fails to disclose any means or methods for the development of ideas through a multi-sided, resource-sharing platform or the quantification of the strength of such resources.

U.S. Pat. No. 9,442,996 to Greenstein et al. teaches the development of a database application across multiple, diverse database management systems through collaborative software. However, the reference fails to disclose any means or methods for the development of ideas through a multi-sided, resource-sharing platform or the quantification of the strength of such resources.

U.S. Pat. No. 9,298,864 by Poulin teaches a system, method, and software product that includes network simulation for mobile application development. However, the reference fails to disclose any means or methods for the development of ideas through a multi-sided, resource-sharing platform or the quantification of the strength of such resources.

U.S. Pat. No. 8,666,993 by Chunilal teaches a system and method for social networking for managing multidimensional life stream related active notes and associated multidimensional active resources and actions. However, the reference fails to disclose any means or methods for the development of ideas through a multi-sided, resource-sharing platform or the quantification of the strength of such resources.

U.S. Pat. No. 7,996,855 by Heist et al. teaches a personal messaging system utilized by a developer in order to add groupware functionality to an application. However, the reference fails to disclose any means or methods for the development of ideas through a multi-sided, resource-sharing platform or the quantification of the strength of such resources.

U.S. Pat. No. 7,802,228 by Madkour et al. teaches a system and methods for building computer executable files with a specific set of build options, or build properties, without modifying a primary file used to specify default build properties for the software under development. However, the reference fails to disclose any means or methods for the development of ideas through a multi-sided, resource-sharing platform or the quantification of the strength of such resources.

US 2016/0224337 by Xia et al. teaches a framework for collaborative software development in an integrated development environment (IDE). However, the reference fails to disclose any means or methods for the development of ideas through a multi-sided, resource-sharing platform or the quantification of the strength of such resources.

US 2015/0199185 Saff et al. teaches a system and method for providing online software development services. However, the reference fails to disclose any means or methods for the development of ideas through a multi-sided, resource-sharing platform or the quantification of the strength of such resources.

There is, therefore, a long-felt but unmet need for methods and means for the development of ideas through a multi-sided, resource-sharing platform or the quantification of the strength of such resources.

### SUMMARY

A system for resource-sharing a software platform, said system further comprising a data processor is provided, wherein said software platform comprises a multi-sided, resource-sharing software platform within which participants both offer and receive tangible and intangible resources to and from a plurality of predefined connections.

### BRIEF DESCRIPTION

The collaborative software platform disclosed herein comprises many different elements, several of which are discussed here in detail. In particular, the claimed platform comprises at least one or more of a plurality of resources, owners, recipients and brokers, and an associated data processor is disposed in communication with the collaborative software platform so that the greatest possible number of contacts, resources, analytics and management tools are available to an operator, said operator being enabled to select from such features in a collaborative environment to the extent preselected in the platform definition.

For present purposes, a Resource may be generally defined as a personal attribute (e.g., expertise, insight, access, etc.) or tangible good deliberately offered for sale, lease, or charity to a predefined connection for benefit, in other words, the platform's common value unit in a given transaction. A personal attribute or tangible good therefore becomes a resource when once it has been offered to another individual or group for sale, lease, or charity.

Similarly, an Owner is the originator, seller, or lessor of a specific Resource; a Recipient is an individual who accepts and thereby receives an offer of Resources from an Owner or Broker; and a Broker is an individual serving as an intermediary between a Resource Owner and a recipient not directly connected to the Owner.

According to the present invention, then, it is considered there are a theoretically infinite number of brokerable Resources applicable within the scope of the instant disclosure. For examples, Resources may comprise either Personal Attribute or Network Resources, though those of ordinary skill in the art will readily appreciate that many other types of Resources may instead be employed with equal efficacy.

The example embodiments disclosed herein for the collaborative software platform of resource-sharing provides the initial link between users through a personal network ensuring a level of safety. It differs from the binary result in which full access or no access is permitted by providing the resource holder with the option to offer to specific users. The methods and means disclosed herein further employs sponsored group exchanges that amplify network value.

In an example embodiment in which Personal Attributes and Network Resources are used, example data sets may comprise:

### For Personal Attributes

P1: A current snapshot of professional information; for example, the industry in which an individual works or is employed; the name and/or business address and contact information for the company with which an individual is affiliated or employed; the primary discipline in which an individual works or is employed; relevant detailed biographic information such as the location address, education, etc., of an individual Resource. In short, P1 comprises a more robust version of information commonly found on business cards.

P2: A more comprehensive professional presentation; for example, the aforementioned P1 information expanded upon to comprise the core components of a résumé.

P3: Individual attributes of a more personal nature; for example, interests, activities, formal associations, etc. In short, P3 compliments the professional information in P1 and/or P2 to essentially form a biography.

P4: Unique information not generally considered typical personal profile attributes; for example, one or more tangible goods, specific Resources called for inside certain predefined groups, attributes integrated from third-party platforms, etc.

### For Network Resources

N1: All Personal Attribute Resources P1-P4 received from and owned by a direct connection.

N2: All resources received through and not owned by a Broker (N1)

### Sharing Parameters

The terms Shareable and Not-Shareable are system-defined attributes of resources in a profile, dependent upon resource origination and the offeror's intent. The system defines this attribute upon receipt/entry into a profile and sets the overarching permission for what is available for further offering and brokering.
P1-P4 attributes in a profile (originated by the user) are shareable—the user can deliberately choose to share them with others.
N1 resources in a profile (those owned/originated by direct connections) are shareable if they were received by the user in a brokerable status.
N1 resources in a profile are not shareable if they were received in a private status (if the offeror chose not to allow the recipient to broker the resource(s)).
All N2 resources (received through and not owned by a broker) are not shareable.

The terms Brokerable and Private are user-defined attributes of resources as they are offered to others, depending upon the offeror's intent. The user defines this attribute upon offering the resource to another individual.
If P1-P4 attributes are offered to connections and denoted as Brokerable, recipients can extend/offer the resource to at most one additional connection. The system prohibits resources from being extended more than two degrees from the originator.
If P1-P4 attributes are offered and denoted as Private, the recipient cannot extend/offer the resource to any additional connection. These resources are system-tagged as Not-Shareable at this point and remain so until the offeror chooses to change the status to Brokerable, either for that specific recipient or for all instances of the specific resource(s) being offered.

A group sharing function facilitates offering a set of resources with specific sharing preferences (as denoted above) to several people at once. Sponsored groups on the other hand pertain to an organization and its affiliated members, and provides a network monitoring system in which the organization has visibility of the resources shared inside the sponsored group.

### Quantifying Resource Strength

Either during or prior to the resource offering process, users can express the degree of strength associated with the offer.
P1 -P4 attributes are given a rating by the owner to indicate how well the owner can leverage the resource for recipients.
As the P1-P4 resources are received and subsequently fall into the N1 section of a user's profile, the recipient quantifies the strength of relationship between the offeror and recipient.
These two metrics combine to quantify both the resource and relationship strength of N1 resources in a profile.
Further downstream, as Brokerable N1 resources are offered to a connection and subsequently fall into the N2 section of the recipient's profile, the recipient quantifies the strength of relationship between the offeror and recipient here again.
This metric combines with the two above to provide the terminal recipient with a quantifiable assessment of both the access to and leverage of specific resources in his or her profile.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from either the spirit or scope thereof.

1. A system for resource-sharing a software platform, said system further comprising a data processor, wherein said software platform comprises a multi-sided, resource-sharing software platform within which participants both offer and receive tangible and intangible resources to and from a plurality of predefined connections.

2. The system of resource-sharing a software platform of claim 1, wherein said collaborative software platform further comprises a plurality of system-defined parameters for the sharing of resources through intermediaries.

3. The system for resource-sharing a collaborative software platform of claim 1, wherein said collaborative software platform further comprises a system quantifying resource strength.

4. The system for resource-sharing a collaborative software platform of claim 1, wherein said collaborative software platform further comprises a network monitoring system used to support engagement and development activities within a sponsored group.

5. The system for resource-sharing a collaborative software platform of claim 1, wherein said collaborative software platform further comprises at least one or more of a plurality of resources, owners, recipients and brokers; and
an associated data processor disposed in communication with the collaborative software platform so that the greatest possible number of contacts, resources, analytics and management tools are available to an operator, said operator being enabled to select from such features in a collaborative environment to an extent preselected in the platform definition.
